(19) United States
(12) Patent Application Publication
(10) Pub. No.: US 2009/0214951 A1
(43) Pub. Date: Aug. 27, 2009

(54) LITHIUM SECONDARY BATTERY

(75) Inventors: Masanori YOSHIKAWA, Hitachinaka (JP); Hidetoshi Honbo, Hitachinaka (JP); Yoshimi Yanai, Kitaibaraki (JP)

Correspondence Address: ANTONELLI, TERRY, STOUT & KRAUS, LLP, 1300 NORTH SEVENTEENTH STREET, SUITE 1800, ARLINGTON, VA, 22209-3873, US

(73) Assignee: Hitachi, Ltd.

(21) Appl. No.: 12/372,848

(22) Filed: Feb. 18, 2009

(30) Foreign Application Priority Data
Feb. 22, 2008 (JP) 2008-041333

(51) Int. Cl. H01M 10/26

(52) U.S. Cl. 429/207

(57) ABSTRACT

To provide a lithium secondary battery having an excellent input and output balance, a high capacity, and a long life. A lithium secondary battery comprising: a positive electrode containing a positive electrode active material which is applied to both sides of a positive electrode collector foil and contains a lithium transition metal complex oxide; a negative electrode containing a negative electrode active material which is applied to both sides of a negative electrode collector foil and occludes and releases lithium; and a nonaqueous electrolytic solution containing a lithium salt, wherein there is an SOC region where a specific input power is almost equal to a specific output power in a range of 20 to 40% of state of charge (SOC) of the lithium secondary battery.

### FIELD OF THE INVENTION

The present invention relates to lithium secondary batteries, and in particular relates to lithium secondary batteries suitable for a plug-in hybrid electric vehicle, the power supply for a fuel-cell vehicle or a power tool and the like.

### BACKGROUND OF THE INVENTION

Power supply devices, such as a lithium secondary battery or a capacitor, intended for application to a fuel cell electric vehicle, a hybrid car, and the like have been actively developed. On-vehicle applications, such as a fuel cell electric vehicle and a hybrid car, require the performances, such as a high load characteristic, a high output power characteristic, and a long-life characteristic. In recent years, requirement for environmentally friendly automotives become severe from the viewpoint of environmental problems, such as carbon dioxide reduction, and thus a plug-in hybrid car combining both advantages of electric drive (EV drive) and hybrid drive (HEV drive) is expected to be developed. Also in the “Proposal for the next-generation automotive battery in future” announced from Ministry of Economy, Trade and Industry in August, 2006, the plug-in hybrid car is expected to be commercialized as the next-generation automotive.

In order to apply the battery to such a next-generation automotive and improve the energy efficiency, it is important to make efficient use of regeneration energy. Although the plug-in hybrid car runs in two modes of EV drive and HEV drive, from a charged battery state to around 30% SOC (state of charge) the plug-in hybrid car performs the EV drive only by the electricity stored in the secondary battery, and then after the remaining capacity of the battery becomes less the plug-in hybrid car will perform the HEV drive at near 30% SOC. In order to commercialize such a plug-in hybrid car, a battery having an excellent input/output balance in a region of 20 to 40% SOC and furthermore having a sufficient performance both in the input and output characteristics is required.

For example, even if the output characteristic is excellent, if the input characteristic is poor the energy regeneration in the HEV operating region will not be performed sufficiently and the energy efficiency will decrease and accordingly the fuel efficiency will also decrease. In contrast, if the input characteristic is excellent but the output characteristic is poor, then the energy regeneration can be performed but the power assist during acceleration becomes insufficient and accordingly again a decrease in the fuel efficiency is a concern. Thus, in the HEV drive, in attempting to improve the energy efficiency, it is extremely important to use a battery having an excellent input/output balance and carry out the power assist effectively utilizing the regeneration energy. The basic characteristics of the lithium battery described above are the characteristics indispensable for the application to the fields of not only the plug-in hybrid car but the power supply for fuel cell electric vehicles and the power supply for power tools that require a high output power, a high capacity, and a long-life.

The battery techniques for electric vehicles or hybrid vehicles have been disclosed. For example, Patent Document 1 discloses a battery technique of a LiMePO₄ (olivine) positive electrode (Me; transition metal element) whose rate of change in the specific output power and the specific input power vs. the state of charge (SOC) is no more than 20% in a range of 25 to 80% SOC. Patent Document 2 discloses a battery technique of a spinel manganese positive electrode whose output power at 80% depth of discharge (20% SOC) is no less than 60% of the output power at 0% depth of discharge (100% SOC).

Moreover, Patent Document 3 discloses a technique for batteries having high charge voltages (4.25 to 4.5V), where the quantity ratio of the positive electrode active material and the negative electrode active material is in a range of 1.3 to 2.2, and the positive electrode active material quantity is in a range of 18.8 to 24.8 mg/cm².

Patent Document 4 describes a lithium battery wherein the active material quantity ratio (between negative electrode and positive electrode) is set to 0.45 to 0.77, but does not describe the SOC and the specific input/output power.

Moreover, Patent Document 5 describes a lithium battery wherein the active material quantity ratio (between negative electrode and positive electrode) is set to 0.25 to 0.5, but does not describe the SOC and the specific input/output power.

[Patent Document 1] JP-A-2003-036889

[Patent Document 2] JP-A-2000-156246

[Patent Document 3] JP-A-2004-342500

[Patent Document 4] JP-A-2003-115329

[Patent Document 5] JP-A-6-275321

### BRIEF SUMMARY OF THE INVENTION

It is an object of the present invention to provide a lithium secondary battery having a well balanced input and output characteristic.

The overview of the present invention is as follows.

(1) A lithium secondary battery comprising: a positive electrode containing a positive electrode active material comprising a lithium transition metal complex oxide; a negative electrode containing a negative electrode active material that occludes and releases lithium; and a nonaqueous electrolytic solution containing a lithium salt, wherein there is an SOC region where a specific input power is almost equal to a specific output power in a range of 20 to 40% of state of charge (SOC).

(2) The lithium battery according to (1), wherein the lithium transition metal complex oxide is represented by a chemical formula LiMO₂ (M is at least one kind of transition metal).

(3) The lithium secondary battery according to (1) or (2), wherein a ratio Ma/Mc between the positive electrode active material quantity Mc (mg/cm²) per unit area in one side of a positive electrode collector foil, to both sides of which the positive electrode active material comprising the lithium transition metal complex oxide is applied, and the negative electrode active material quantity Ma (mg/cm²) per unit area in one side of a negative electrode collector foil, to both sides of which the negative electrode active material is applied, is in a range of 0.5 to 0.7.

(4) The lithium secondary battery according to any one of (1) to (3), wherein the positive electrode active material quantity Mc (mg/cm²) per unit area in one side of the positive electrode collector foil is in a range of 9 mg/cm² to 14 mg/cm².

(5) A lithium secondary battery for a plug-in hybrid electric vehicle, the lithium secondary battery comprising: a positive electrode containing a positive electrode active material which is applied to both sides of a positive electrode collector foil and contains a lithium transition metal complex oxide; an negative electrode containing a negative electrode active material which is applied to both sides of a negative electrode collector foil and occludes and releases lithium; and a nonaqueous electrolytic solution containing a lithium salt, wherein there is an SOC region where a specific input power is almost equal to a specific output power in a range of 20 to 40% of state of charge (SOC) of the lithium secondary battery, and wherein a specific energy is no less than 100 Wh/kg.

(6) The lithium secondary batteries for a plug-in hybrid electric vehicle according to (5), wherein the specific input power and the specific output power that are equal to each other in the range of 20 to 40% SOC is no less than 2000 W/kg.

### BRIEF DESCRIPTION OF DRAWINGS

FIG. 1 is a side cross-sectional view showing a lithium secondary battery according to the present invention.

FIG. 2 is a view showing the input and output characteristics of a lithium secondary battery according to the present invention.

FIG. 3 is a view showing the load characteristics of lithium secondary batteries according to the present invention.

FIG. 4 is a view showing the input and output characteristics of a lithium secondary battery according to the present invention.

### DESCRIPTION OF REFERENCE NUMERALS

1 . . . positive electrode, 2 . . . negative electrode, 3 . . . separator, 4 . . . battery can, 5 . . . positive electrode collector lead piece, 6 . . . negative electrode collector lead piece, 7 . . . positive electrode collector lead portion, 8 . . . negative electrode collector lead portion, 9 . . . battery lid, 10 . . . safety rupture valve, 11 . . . positive electrode terminal portion, 12 . . . gasket

### DETAILED DESCRIPTION OF THE INVENTION

After conducting intensive study to solve the above-described problems, the present inventors have found that a lithium battery having a well-balanced input/output characteristic can be provided in the case where there is an SOC region where a specific input power is almost equal to a specific output power in a range of 20 to 40% of state of charge (SOC) of the lithium secondary battery. This SOC region where the specific input power is almost equal to the specific output power refers to a point where the specific input power intersects with the specific output power in a graph showing a relationship between the specific input/output power and SOC, or a region near this point. For example, in the cases of FIG. 2 and FIG. 4, the above-described intersecting point in the SOC exists at near about 30% SOC, however, for example, including a case where this intersecting point exists at near the boundary of 20 to 40% SOC, the specific input power was determined to be almost equal to the specific output power. However, the difference between the specific input power and the specific output power is preferably as small as possible, and the intersecting point between the specific input/output powers (where the difference between the specific input/output powers is 0) is most preferably in a range of 20 to 40% SOC. Even if there is a difference, the difference between the specific input power and the specific output power may be less than or equal to 1.0%, more preferably less than or equal to 0.5%.

An example of a technical means in the present invention for setting the intersecting point of the specific input/output powers to 20 to 40% SOC or for causing the specific input/output powers to intersect at the SOC in the vicinity thereof is described below. First, by setting the ratio between the positive electrode active material quantity and the negative electrode active material quantity to a suitable value, the above-described problems can be solved. The present inventors have found that a battery applicable to a plug-in hybrid electric vehicle having two drive modes of EV drive and HEV drive of a plug-in hybrid electric vehicle, the battery being suitable for the plug-in hybrid electric vehicle and having no difference between the specific input/output powers in a range of 20 to 40% SOC or having an extremely small difference between the specific input/output powers, can be provided.

The lithium secondary battery of the present invention is directed to a lithium secondary battery comprising: a positive electrode containing a positive electrode active material comprising a lithium transition metal complex oxide; a negative electrode containing a negative electrode active material that occludes and releases lithium; and a nonaqueous electrolytic solution containing a lithium salt. This lithium battery has an SOC region where the specific input power is almost equal to the specific output power in a range of 20 to 40% state of charge (SOC).

In order to balance between the input and the output characteristics in a region where the SOC is low (20 to 40%), it is preferable to increase the specific output power in this region and thereby improve the battery performance. To do this, it is important to set the Ma/Mc ratio between the positive electrode active material quantity Mc (mg/cm²) and the negative electrode active material quantity Ma (mg/cm²) to a suitable value.

If the Ma/Mc ratio is reduced, i.e., if the negative electrode active material quantity is relatively reduced to increase the positive electrode active material quantity, then the battery will operate in a region where the negative electrode potential is low. Accordingly, the battery voltage in a low SOC region will increase and a high output power can be expected. However, if the negative electrode active material quantity is reduced too much, then lithium dendrite will be produced in the negative electrode, which raises concerns about a decrease in the safety and reliability of the battery and increases the load on the negative electrode during battery operation, thereby increasing the difficulty of securing the battery life as well. On the other hand, if the Ma/Mc ratio is increased, then an increase of the irreversible capacitance of the negative electrode would reduce the battery capacity and reduce the output power in the low SOC region.

Study based on these points indicates that the Ma/Mc ratio in a range of 0.5 to 0.7 is suitable. More preferably, the Ma/Mc ratio be in a range of 0.52 to 0.68.

Furthermore, in order to apply to plug-in hybrid electric vehicles, not only the input and output balance in a low SOC region but also high input/output powers are required. In order to obtain high specific input/output powers, it is important to increase the electrode area of a group of electrodes, which can be housed in a limited space within a battery can, and to make the electrode resistance as low as possible, by making a thin electrode with a reduced positive electrode active material quantity per unit area of the collector foil having a large electric resistance.

However, if the positive electrode active material quantity is reduced in order to thin the electrode, the fear is that the battery capacity becomes small accordingly and the distance of EV drive which is the feature of the plug-in hybrid electric vehicle becomes short. Then, it turned out that a sufficient battery capacity can be obtained when the positive electrode active material quantity Mc per unit area in one side of the positive electrode collector foil is in a range of 9 to 14 mg/cm², more preferably in a range of 9.4 to 13.7 mg/cm².

On the other hand, for the negative electrode active material, the use of graphite-like material with a low electrode potential is preferable to obtain a high output power in a low SOC region.

The positive electrode used for the lithium secondary battery of the present invention is formed by applying a positive electrode mixture comprising a positive electrode active material, a conductive agent, and a binder to both sides of an aluminium foil and afterward drying and pressing this. As the positive electrode active material, the one represented by a chemical formula LiMO₂ (M is at least one kind of transition metal) can be used. Some of Mn, Ni, Co, and the like within the positive electrode active material, such as a lithium manganese oxide, a lithium nickel oxide, and a lithium cobalt oxide, can be substituted with one kind or two or more kinds of transition metals and be used. Furthermore, some of the transition metals can be also substituted with a metallic element, such as Mg or Al, and be used.

As the conductive agent, a known conductive material, e.g., a carbon-based conductive material, such as graphite, acetylene black, carbon black, or carbon fiber, may be used, but not limited in particular.

As the binder, a known binder, e.g., polyvinylidene fluoride, fluororubber, or the like, may be used, but not limited in particular. In the present invention, a preferable binder is polyvinylidene fluoride, for example.

Moreover, as for the solvent, various known solvents may be appropriately selected and used, and for example, an organic solvent, such as N-methyl-2-pyrrolidone, is preferably used.

The mixing ratio of the positive electrode active material, the conductive agent, and the binder in the positive electrode mixture is not limited in particular, however, for example, 1:0.05-0.20:0.02-0.10 in weight ratio is preferable, where the positive electrode active material is 1.

The positive electrode used for the lithium secondary battery of the present invention is formed by applying a negative electrode mixture comprising a negative electrode active material and a binder to both sides of a copper foil and afterward drying and pressing this. In the present invention, a preferable one is a graphite material.

As the binder, for example, the same one as that of the above-described positive electrode is used, but not limited in particular. In the present invention, a preferable one is polyvinylidene fluoride, for example. The preferable solvent is an organic solvent, such as N-methyl-2-pyrrolidone, for example. The mixing ratio of the negative electrode active material and the binder in the negative electrode mixture is in a range of 5 to 0.20, but not limited in particular.

As the nonaqueous electrolytic solution used in the lithium battery of the present invention, a known one may be used, but not limited in particular. The examples of the nonaqueous solution include propylene carbonate, ethylene carbonate, butylene carbonate, vinylene carbonate, dimethyl carbonate, diethyl carbonate, methyl-ethyl carbonate, tetrahydrofuran, 1,2-diethoxyethane, and the like. The organic electrolytic solution can be adjusted by dissolving one or more kinds of lithium salts selected, for example, from LiPF₆, LiBF₄, LiC₄, and the like into one or more kinds of these solvents. Moreover, a microporous separator, e.g., a polyolefine-based microporous polymer membrane, may be used depending on the configuration need of a battery, and the expected advantages of the present invention can be obtained.

The shapes of the lithium secondary battery include a spirally wound type, a stacked type, and the like, but not limited in particular. The lithium secondary battery of the present invention can be manufactured, for example, as follows, when it is cylindrical.

A conductive agent such as graphite, and a binder such as polyvinylidene fluoride dissolved into a solvent, such as N-methyl-2-pyrrolidone, are added into a positive electrode active material in the above-described weight ratio, and this is kneaded to obtain a positive electrode slurry.

Next, this slurry is applied to both sides of the aluminum metal foil of the collector. In this case, this slurry is applied so that the positive active material quantity per unit area in one side of the collector foil may be in a range of 9 mg/cm² to 14 mg/cm². Thereafter, this is dried and pressed to prepare the positive electrode.

Next, the polyvinylidene fluoride dissolved into N-methyl-2-pyrrolidone or the like is added as the binder into the negative electrode active material in the above-described weight ratio, and this is then kneaded to obtain a negative electrode slurry. Next, this slurry is applied to both sides of the copper foil of the collector, and afterward this is dried and pressed to prepare the negative electrode. LiPF₆ or the like is dissolved into a nonaqueous solvent of ethylene carbonate or the like to prepare a nonaqueous electrolytic solution.

A separator of a microporous insulating material is sandwiched between both electrodes of the obtained positive electrode and negative electrode, and this is rolled up and afterward inserted into a battery can that is molded with stainless steel or aluminium. After connecting a lead piece of the electrode to the battery can, the nonaqueous electrolytic solution is injected, and then the battery can is sealed to obtain the lithium ion secondary battery.

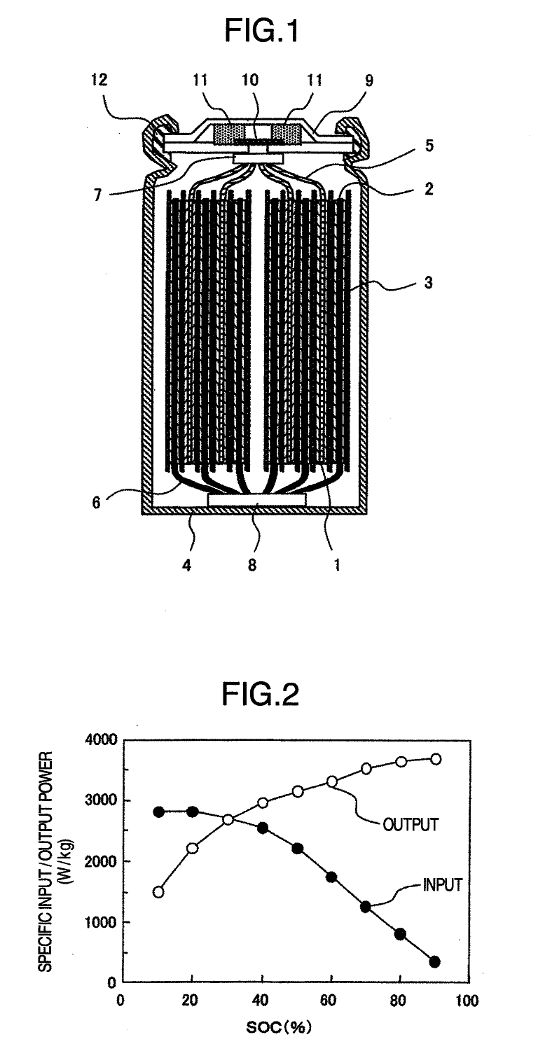

An example of the cylindrical lithium secondary battery to which the present invention is applied is shown in FIG. 1. The cylindrical lithium secondary battery comprises: a positive electrode 1 comprising an aluminium foil, to both sides of which the above-described positive electrode mixture is applied; a negative electrode 2 comprising a copper foil, to both sides of which the above-described negative electrode mixture is applied; a separator 3 arranged between the positive electrode 1 and the negative electrode 2; a positive electrode collector lead piece 5 for connecting the positive electrode 1 to a positive electrode collector lead portion 7; a negative electrode collector lead piece 6 for connecting the negative electrode 2 to a negative electrode collector lead portion 8; a battery can 4, to the bottom surface of which the negative electrode collector lead portion 8 is connected; a battery lid 9 that is secured to an open end of the battery can 4 by crimping via a gasket 12; a positive electrode terminal portion 11 in contact with the rear surface of the battery lid 9; and a safety rupture valve 10 sandwiched between the positive electrode terminal portions 11.

The positive electrode 1 and the negative electrode 2 are rolled up via the separator 3, and are arranged as a group of electrodes inside the battery can 4. A space formed by the battery can 4 and the battery lid 9 is filled with the electrolytic solution (not shown).

As the application of the lithium secondary battery of the present invention, as described-above, the application to the field of automobiles, such as a plug-in hybrid electric vehicle, a fuel cell electric vehicle, and an electric vehicle, and furthermore the application as the power supply for the power tools or the like requiring a high load characteristic and a high output power are possible. Moreover, since the active material quantity has been optimized, a lightweight and compact lithium secondary battery having a well-balanced specific input power and specific output power in a low SOC region can be obtained.

### EXAMPLES

Hereinafter, the present invention will be described using examples, however, the present invention is not limited to the examples described below.

### Example 1

LiNi_{0.65}Mn_{0.20}Co_{0.15}O₄ was used as the positive electrode active material, and this positive electrode active material, graphite of the conductive agent, and polyvinylidene fluoride of the binder were kneaded in a weight ratio of 85:10:5 for 30 minutes using a kneading machine, and then a slurry of the positive electrode mixture was obtained. This slurry was applied to both sides of an aluminium foil, i.e., the collector, with a thickness of 20 μm. The positive electrode active material quantity per unit area in one side of the collector foil was 11.4 mg/cm². On the other hand, natural graphite was used as the negative electrode active material and polyvinylidene fluoride was used as the binder, and these were kneaded in a weight ratio of negative electrode active material:binder=90:10. The obtained slurry of the negative electrode mixture was applied to both sides of the copper foil with a thickness of 10 μm.

The Ma/Mc ratios between the positive electrode active material quantity and the negative electrode active material quantity (Ma) per unit area in one side of the collector foil (Mc) were 0.45, 0.52, 0.60, 0.68, and 0.75. Each of the prepared positive/negative electrodes was rolled and molded using a pressing machine, and afterward dried in a vacuum at 150° C. for 5 hours.

After drying, the positive electrode and the negative electrode were rolled up via the separator and inserted into the battery can. The negative electrode collector lead pieces 6 were collected at the negative electrode collector lead portion 8 and were ultrasonically welded together, and the collector lead portion was welded to the can bottom.

On the other hand, after ultrasonically welding the positive electrode collector lead piece 5 to the positive electrode collector lead portion 7, an aluminium lead portion was resistance-welded to the battery lid 9. After injecting an electrolytic solution (LiPF₆/EC:MEC=1:2), the battery lid 9 was sealed by crimping the battery can 4, thereby obtaining the battery. Note that the gasket 12 was inserted between the upper end of the battery can 4 and the battery lid 9. A schematic illustration of thus manufactured battery is shown in FIG. 1.

The battery capacity was determined by charging and discharging with an end-of-charge voltage of 4.2V, an end-of-discharge voltage of 2.7V, and a charge-discharge rate of 1 C (one hour rate). Based on this capacity, the input/output characteristic was investigated by varying SOC by 10% each time in a range of 10 to 90% SOC. The input/output characteristic was determined from the current-voltage characteristic after applying the currents of 1 C, 5 C, 10 C, and 20 C for 11 seconds and measuring a voltage at the 10th second in each current value. That is, the output power (P_{O}) was calculated from Equation P_{O}=I_{D}×V_{D} using an end-of-discharge voltage (V_{D}) of a battery and a current value (I_{D}) obtained when extrapolating a straight line of the current-voltage characteristic to the end-of-discharge voltage. On the other hand, the input power was calculated from Equation P_{I}=I_{C}×V_{C} using an end-of-charge voltage (V_{C}) of the battery, and a current value (I_{C}) obtained when extrapolating the straight line of the current-voltage characteristic to the end-of-charge voltage. Table 1 shows the Ma/Mc ratio of prototyped batteries along with SOC at which the specific input/output powers indicate the equal value, the specific input/output power, and the specific energy. FIG. 2 shows an example of the input/output test result. This view shows the result of Battery 1-2.

TABLE 1

| | | | Specific input/ | |
|---|---|---|---|---|
| Battery | Ma/Mc | SOC | output power | Specific energy |
| number | ratio | (%) | (W/kg) | (W/kg) |
| 1-1 | 0.45 | 24 | 2760 | 115 |
| 1-2 | 0.52 | 30 | 2670 | 112 |
| 1-3 | 0.60 | 36 | 2510 | 107 |
| 1-4 | 0.68 | 38 | 2420 | 102 |
| 1-5 | 0.75 | 41 | 2320 | 97 |

Each of the batteries showed a high specific input/output power exceeding 2000 W/kg, but in Battery 1-5 whose Ma/Mc ratio is 0.75, as compared with Battery 1-1 whose Ma/Mc ratio is 0.45 having a high quantity of negative electrode active material, the specific energy is 97 Wh/kg, which is a value less than 100 Wh, and the value of SOC, at which the specific input/output powers are equal, also showed a high value (41%).

Next, a charge-discharge cycle test was conducted by charging and discharging in a range of 30 to 90% SOC. The open circuit voltage at 90% SOC was defined as the end-of-charge voltage and the open circuit voltage at 30% SOC was defined as the end-of-discharge voltage, and the charge-discharge cycle test was conducted at a charge and discharge current values of 5 C. The quiescent time was set to 10 minutes both in charging and discharging.

As a result of investigation on the battery capacity change as described above, the capacity retention at 2000 cycles relative to the initial capacity was a small value (71%) for a small Ma/Mc ratio (Ma/Mc ratio=0.45). However, for Battery 1-2 to Battery 1-5 with a large Ma/Mc ratio, the capacity retention was 82% in Battery 1-2, 83% in Battery 1-3, 85% in Battery 1-4, and 84% in Battery 1-5, and each of the batteries has a value exceeding 80%.

### Example 2

Using LiNi_{0.55}Mn_{0.25}Co_{0.20}O₄ as the positive electrode active material, and using artificial graphite as the negative electrode active material, a battery was prepared as in Example 1. Here, the quantities of the positive electrode active material and the negative electrode active material were adjusted so that the Ma/Mc ratio may become 0.60.

The positive electrode active material quantity in one side of the collector foil was 8.1 mg/cm², 9.4 mg/cm², 10.8 mg/cm², 12.3 mg/cm², 13.7 mg/cm², and 14.8 mg/cm², respectively. The specific input/output power of each of the prototyped batteries was investigated as in Example 1. Table 2 shows the result. With either battery, a high specific input/output power exceeding 2000 W/kg was obtained, however, for Battery 2-1 whose positive electrode active material quantity is small (8.1 mg/cm²), the specific energy was 97 Wh/kg, which is a small value less than 100.

TABLE 2

| | Positive | | | |
|---|---|---|---|---|
| | electrode active | | Specific input/ | Specific |
| Battery | material quantity | SOC | output power | energy |
| number | (mg/cm²) | (%) | (W/kg) | (W/kg) |
| 2-1 | 8.1 | 30 | 2870 | 97 |
| 2-2 | 9.4 | 31 | 2640 | 103 |
| 2-3 | 10.8 | 31 | 2430 | 107 |
| 2-4 | 12.3 | 30 | 2240 | 115 |
| 2-5 | 13.7 | 32 | 2080 | 119 |
| 2-6 | 14.8 | 31 | 2030 | 121 |

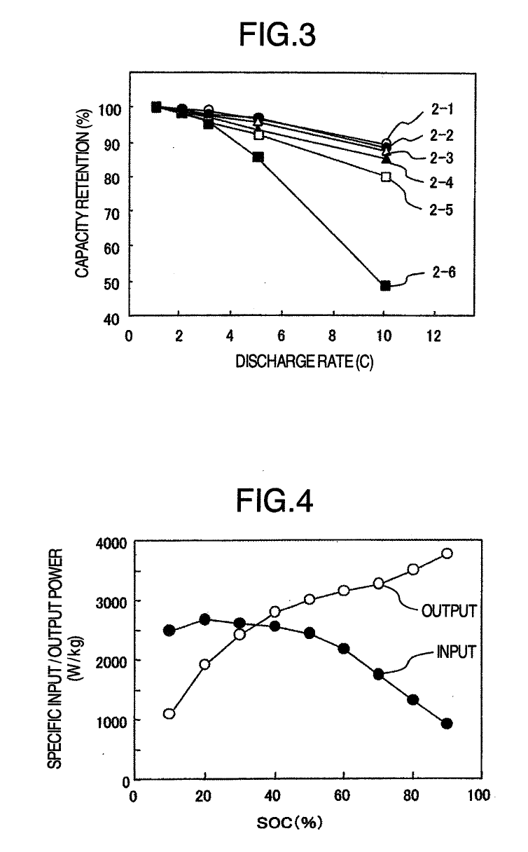

Next, the load characteristic was investigated. The battery capacity that was determined as in Example 1 was defined as a rated capacity, and after charging the rated capacity, the rated capacity was discharged at current values 1 C, 2 C, 3 C, 5 C and 10 C to determine the discharge capacity. Note that the end-of-discharge voltage was set to 2.7 V. FIG. 3 shows the result. Note that the graph shows the capacity retention with the capacity during discharge at 1 C defined as 100%. While each of Battery 2-1 to Battery 2-5 showed a high load characteristic with the capacity retention at 10 C no less than 80%, Battery 2-6 showed a low value (below 50%).

### Example 3

Using LiNi_{0.70}Mn_{0.15}Co_{0.10}Al_{0.05}O₂ as the positive electrode active material, and using artificial graphite as the negative electrode active material, a battery was prepared as in Example 1. The Ma/Mc ratio was 0.55 and the positive electrode active material quantity in one side of the collector foil was 12.0 mg/cm². FIG. 4 shows the result of input/output characteristics that was investigated similarly to Example 1. A high specific input/output power exceeding 2000 W/kg at 30% SOC was obtained. The specific energy was 109 Wh/kg.

In the foregoing, the present invention has been described in detail with reference to the examples. According to the present invention, a lithium battery having a high specific energy no less than 100 Wh/kg over a wide SOC region can be provided. This characteristic is an important characteristic particularly in a plug-in hybrid electric vehicle. Moreover, the specific input/output power is also equal to or higher than 2000 W/kg, which is also the characteristic that the lithium battery according to the present invention is particularly suitable for a plug-in hybrid electric vehicle.

### Advantages of the Invention

According to the present invention, there is provided a lithium secondary battery having an excellent input and output balance, a high capacity, and a long life. The lithium battery according to the present invention is suitable for plug-in hybrid electric vehicles, in particular, but is widely applicable to other uses, for example, to the fields of a fuel cell electric vehicle, an electric vehicle, a power tool, or the like that requires a high output power and a high capacity.

1. A lithium secondary battery, comprising:
a positive electrode containing a positive electrode active material which is applied to both sides of a positive electrode collector foil and contains a lithium transition metal complex oxide;
a negative electrode containing a negative electrode active material which is applied to both sides of a negative electrode collector foil and occludes and releases lithium; and
a nonaqueous electrolytic solution containing a lithium salt,
wherein there is an SOC region where a specific input power is almost equal to a specific output power in a range of 20 to 40% of state of charge (SOC) of the lithium secondary battery.

2. The lithium secondary battery according to claim 1, wherein the lithium transition metal complex oxide is represented by a chemical formula LiMO₂ (M is at least one kind of transition metal).

3. The lithium secondary battery according to claim 1, wherein a ratio Ma/Mc between a quantity Mc (mg/cm²) of the positive electrode active material per unit area in one side of the positive electrode collector foil and a quantity Ma (mg/cm²) of the negative electrode active material per unit area in one side of the negative electrode collector foil is in a range of 0.5 to 0.7.

4. The lithium secondary battery according to claim 1, wherein the quantity Mc (mg/cm²) of the positive electrode active material per unit area in one side of the positive electrode collector foil is in a range of 9 to 14 mg/cm².

5. A lithium secondary battery for a plug-in hybrid electric vehicle, the lithium secondary battery comprising:
a positive electrode containing a positive electrode active material which is applied to both sides of a positive electrode collector foil and contains a lithium transition metal complex oxide;
a negative electrode containing a negative electrode active material which is applied to both sides of a negative electrode collector foil and occludes and releases lithium; and
a nonaqueous electrolytic solution containing a lithium salt,
wherein there is an SOC region where a specific input power is almost equal to a specific output power in a range of 20 to 40% of state of charge (SOC) of the lithium secondary battery, and
wherein a specific energy is no less than 100 Wh/kg.

6. The lithium secondary battery for a plug-in hybrid electric vehicle according to claim 5, wherein the specific input power and the specific output power that are almost equal to each other in the range of 20 to 40% of state of charge (SOC) are no less than 2000 W/kg.

7. The lithium secondary battery for a plug-in hybrid electric vehicle according to claim 5, wherein the lithium transition metal complex oxide is represented by a chemical formula LiMO₂ (M is at least one kind of transition metal).

8. The lithium secondary battery for a plug-in hybrid electric vehicle according to claim 5, wherein a ratio Ma/Mc between a quantity Mc (mg/cm²) of the positive electrode active material per unit area in one side of the positive electrode collector foil and a quantity Ma (mg/cm²) of the negative electrode active material per unit area in one side of the negative electrode collector foil is in a range of 0.5 to 0.7.

9. The lithium secondary battery for a plug-in hybrid electric vehicle according to claim 5, wherein the quantity Mc (mg/cm²) of the positive electrode active material per unit area in one side of the positive electrode collector foil is in a range of 9 to 14 mg/cm².
